(19) United States
(12) Patent Application Publication
(10) Pub. No.: US 2024/0260030 A1
(43) Pub. Date: Aug. 1, 2024

(54) CHANNEL OCCUPANCY INITIATOR DETERMINATION FOR TRANSMISSIONS IN UNLICENSED SPECTRUM

(71) Applicant: Lenovo (Singapore) Pte. Ltd., New Tech Park (SG)

(72) Inventors: Hossein Bagheri, Urbana, IL (US); Alexander Johann Maria Golitschek Edler von Elbwart, Darmstadt (DE); Hyejung Jung, Northbrook, IL (US); Ankit Bhamri, Rödermark (DE); Vijay Nangia, Woodridge, IL (US); Joachim Löhr, Wiesbaden (DE)

(21) Appl. No.: 18/559,494

(22) PCT Filed: May 9, 2022
(86) PCT No.: PCT/IB2022/054292

§ 371 Date: Nov. 7, 2023

Related U.S. Application Data
(60) Provisional application No. 63/185,959, filed on May 7, 2021.

(51) Int. Cl. H04W 72/1268; H04W 72/23; H04W 74/0808

(52) U.S. Cl. CPC H04W 72/1268; H04W 74/0808; H04W 72/23

(57) ABSTRACT

Apparatuses, methods, and systems are disclosed for channel occupancy initiator determination for transmissions in unlicensed spectrum. An apparatus (700) includes a transceiver (725) that receives a scheduling downlink control information (“DCI”) for scheduling a set of physical uplink shared channel (“PUSCH”) transmissions, the set of PUSCH transmissions comprising at least two PUSCH transmissions. The apparatus (700) includes a processor (705) that determines a channel occupancy time (“COT”) initiator for each PUSCH transmission of the set of PUSCH transmissions and determines a set of COTs associated with the set of PUSCH transmissions based on the determined COT initiator for each PUSCH transmission of the set of PUSCH transmissions. The transceiver (725) transmits the set of PUSCH transmissions without transmitting a set of symbols of the set of PUSCH transmissions that overlap with idle periods of the determined set of COTs.

### CROSS-REFERENCE TO RELATED APPLICATIONS

This application claims the benefit of United States Provisional Patent Application Number 63/185,959, entitled “CHANNEL OCCUPANCY INITIATOR DETERMINATION FOR UL TRANSMISSIONS IN UNLICENSED SPECTRUM” and filed on May 7, 2021, for Hossein Bagheri, et al., which is incorporated herein by reference.

### FIELD

The subject matter disclosed herein relates generally to wireless communications and more particularly relates to channel occupancy initiator determination for transmissions in unlicensed spectrum.

### BACKGROUND

In wireless networks, user devices such as user equipment (“UE”) and network nodes such as gNBs that operate in unlicensed spectrum may be required to perform a clear channel assessment (“CCA”) e.g., by using listen-before-talk ((“LBT”) also referred to as channel sensing) prior to being able to transmit in the unlicensed spectrum. If the device/network node performing LBT does not detect the presence of other signals in the channel, the medium/channel is considered available for transmission. In frame-based equipment (“FBE”) mode of operation, the device/network node performs LBT during an idle period and once the channel/medium is acquired, the device/network node can communicate within the non-idle time of a fixed frame period (“FFP”) duration (e.g., also referred to as a channel occupancy time (“COT”)).

### BRIEF SUMMARY

Disclosed are solutions for channel occupancy initiator determination for transmissions in unlicensed spectrum.

In one embodiment, a first apparatus includes a transceiver that receives a scheduling downlink control information (“DCI”) for scheduling a set of physical uplink shared channel (“PUSCH”) transmissions, the set of PUSCH transmissions comprising at least two PUSCH transmissions. In one embodiment, the first apparatus includes a processor that determines a channel occupancy time (“COT”) initiator for each PUSCH transmission of the set of PUSCH transmissions and determines a set of COTs associated with the set of PUSCH transmissions based on the determined COT initiator for each PUSCH transmission of the set of PUSCH transmissions. In one embodiment, the transceiver transmits the set of PUSCH transmissions without transmitting a set of symbols of the set of PUSCH transmissions that overlap with idle periods of the determined set of COTs.

In one embodiment, a first method receives a scheduling downlink control information (“DCI”) for scheduling a set of physical uplink shared channel (“PUSCH”) transmissions, the set of PUSCH transmissions comprising at least two PUSCH transmissions. In one embodiment, the first method determines a channel occupancy time (“COT”) initiator for each PUSCH transmission of the set of PUSCH transmissions and determines a set of COTs associated with the set of PUSCH transmissions based on the determined COT initiator for each PUSCH transmission of the set of PUSCH transmissions. In one embodiment, the first method transmits the set of PUSCH transmissions without transmitting a set of symbols of the set of PUSCH transmissions that overlap with idle periods of the determined set of COTs.

In one embodiment, a second apparatus includes a transceiver that transmits, to a user equipment (“UE”), a scheduling downlink control information (“DCI”) for scheduling a set of physical uplink shared channel (“PUSCH”) transmissions, the set of PUSCH transmissions comprising at least two PUSCH transmissions and receives, from the UE, the set of PUSCH transmissions, the set of PUSCH transmissions not comprising a set of symbols that overlap with idle periods of a set of channel occupancy times (“COTs”) associated with the set of PUSCH transmissions.

In one embodiment, a second method transmits, to a user equipment (“UE”), a scheduling downlink control information (“DCI”) for scheduling a set of physical uplink shared channel (“PUSCH”) transmissions, the set of PUSCH transmissions comprising at least two PUSCH transmissions and receives, from the UE, the set of PUSCH transmissions, the set of PUSCH transmissions not comprising a set of symbols that overlap with idle periods of a set of channel occupancy times (“COTs”) associated with the set of PUSCH transmissions.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for channel occupancy initiator determination for transmissions in unlicensed spectrum;

FIG. 2 depicts a fixed frame period structure:

FIG. 3 depicts the DCI schedules PUSCH-g and PUSCH-u;

FIG. 4 depicts an example where UE1 has already initiated a COT due to first CG-PUSCH transmission;

FIG. 5 depicts a multi-PUSCH transmission scheduled by the DCI;

FIG. 6 is a diagram illustrating one embodiment of a NR protocol stack;

FIG. 7 is a block diagram illustrating one embodiment of a user equipment apparatus that may be used for channel occupancy initiator determination for transmissions in unlicensed spectrum:

FIG. 8 is a block diagram illustrating one embodiment of a network apparatus that may be used for channel occupancy initiator determination for transmissions in unlicensed spectrum:

FIG. 9 is a flowchart diagram illustrating one embodiment of a method for channel occupancy initiator determination for transmissions in unlicensed spectrum; and

FIG. 10 is a flowchart diagram illustrating one embodiment of another method for channel occupancy initiator determination for transmissions in unlicensed spectrum.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures Like numbers refer to like elements in all figures, including alternate embodiments of like elements.

Generally, the present disclosure describes systems, methods, and apparatuses for channel occupancy initiator determination for transmissions in unlicensed spectrum. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For operation in unlicensed spectrum, especially in a semi-static channel access (operation according to FBE), downlink and uplink transmissions are allowed after a node such as agNB or a UE has acquired the shared channel by a successful clear channel assessment, following an LBT procedure. The procedures for gNBs and UEs acquiring a COT have been specified in 3GPP NR Rel-16 for both dynamic and semi-static channel access, except for UEs initiating a COT for semi-static channel access.

Determination of ownership of a COT (e.g., which device has initiated the COT) at both the gNB and the UE for a transmission, e.g., an uplink (“UL”) transmission, is needed to determine:

Whether another UE can send another UL transmission within the COT:

Which idle period (e.g., the gNBs or the UEs) should be respected (e.g., an UL transmission is not allowed within the respected idle period); and/or

The energy detect (“ED”) threshold, which might be different, for example, in cases where the gNB shares UE-COT or UE-initiated COT or might be different if the ED threshold is determined based on UE transmit power, and/or gNB transmit power.

In one embodiment, the subject matter disclosed herein provides mechanisms to determine the COT initiator for each physical uplink shared channel (“PUSCH”) transmission of a multi-PUSCH transmission or for each repetition of PUSCH repetitions, wherein the multiple PUSCH transmissions or repetitions are scheduled by a single DCI.

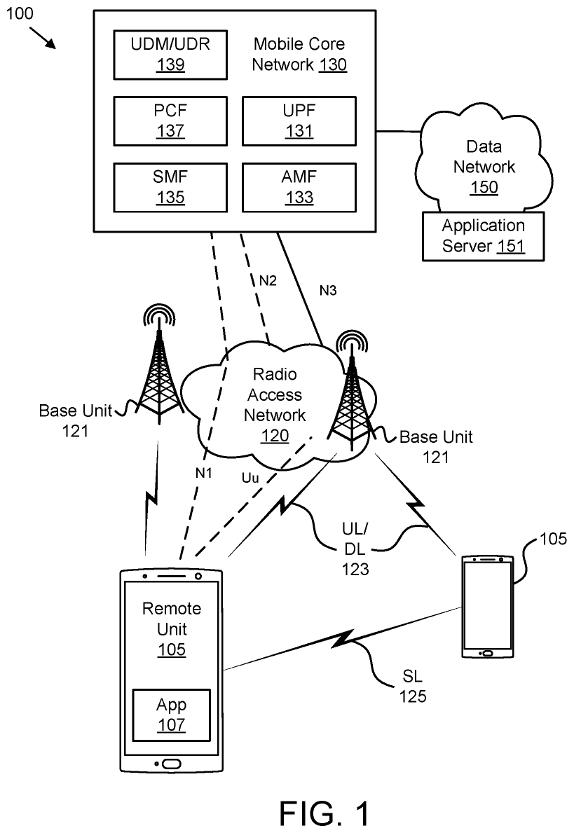

FIG. 1 depicts a wireless communication system 100 supporting CSI enhancements for higher frequencies, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-FiR or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QOS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) 136, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

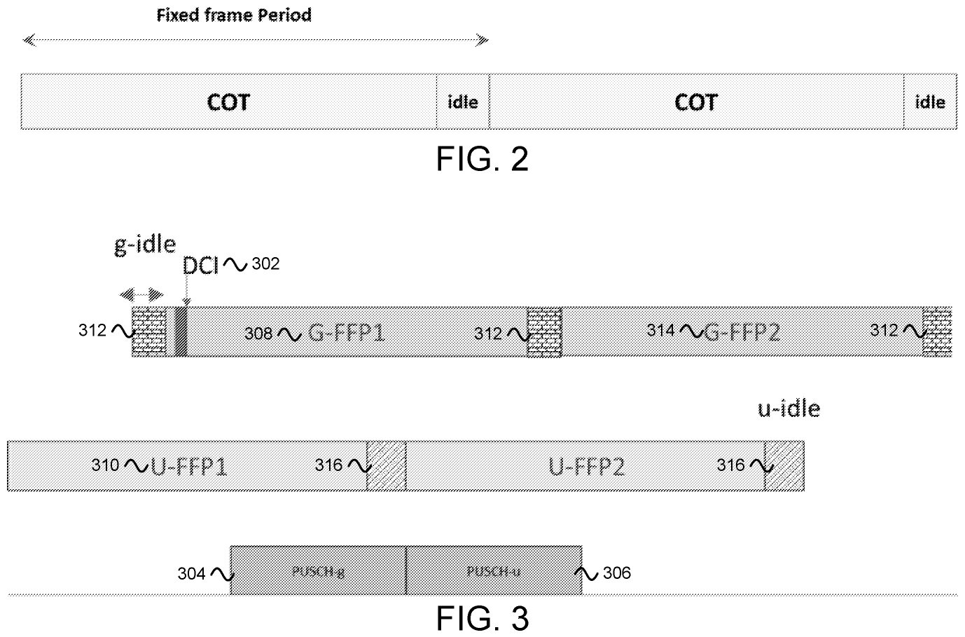

Regarding operation in unlicensed spectrum, UE devices or other network nodes, such as gNBs, that operate in an unlicensed spectrum may be required to perform a CCA e.g., using LBT (also referred to as channel sensing) prior to being able to transmit in the unlicensed spectrum. If the device/network node performing LBT does not detect the presence of other signals in the channel, the medium/channel is considered available for transmission. In FBE mode of operation, the device/network node performs LBT in an idle period and once acquired the channel/medium, the device/network node can communicate within the non-idle time of a fixed frame period duration (referred to as COT), as shown in FIG. 2. In certain specifications/regulations, the idle time is not shorter than the maximum of 5% of the FFP and 100 microseconds.

Regarding UE initiated channel occupancy (“CO”), a UE can perform channel sensing and access the channel if it senses the channel to be idle. UE initiated CO has not been specified in Rel-16 for FBE-based equipment (semi-static channel access). UE initiated CO could be useful especially in low-latency applications, wherein having UL data to be sent in configured grant resources is allowed to initiate a CO.

In one embodiment, if a gNB shares a channel occupancy initiated by a UE using the channel access procedures described in clause 4.2.1.1 of TS 37.213 on a channel, the gNB may transmit a transmission that follows a UL transmission on scheduled resources or a PUSCH transmission on configured resources by the UE after a gap as follows:
The transmission shall contain transmission to the UE that initiated the channel occupancy and can include non-unicast and/or unicast transmissions where any unicast transmission that includes user plane data is only transmitted to the UE that initiated the channel occupancy.
If the higher layer parameters ul-toDL-COT-SharingED-Threshold-r16 is not provided, the transmission shall not include any unicast transmissions with user plane data and the transmission duration is not more than the duration of 2, 4 and 8 symbols for subcarrier spacing of 15, 30 and 60 kHz of the corresponding channel, respectively.
If the gap is up to 16 us, the gNB can transmit the transmission on the channel after performing Type 2C DL channel access as described in clause 4.1.2.3 of TS 37.213.
If the gap is 25 us or 16 us, the gNB can transmit the transmission on the channel after performing Type 2A or Type 2B DL channel access procedures as described in clause 4.1.2.1 and 4.1.2.2 of TS 37.213, respectively.

For the case where a gNB shares a channel occupancy initiated by a UE with configured grant PUSCH transmission, the gNB may transmit a transmission that follows the configured grant PUSCH transmission by the UE as follows:
If the higher layer parameter ul-toDL-COT-SharingED-Threshold-r16 is provided, the UE is configured by cg-COT-SharingList-r16 where cg-COT-SharingList-r16 provides a table configured by higher layer. Each row of the table provides a channel occupancy sharing information given by higher layer parameter CG-COT-Sharing-r16. One row of the table is configured for indicating that the channel occupancy sharing is not available.
If the ‘COT sharing information’ in CG-UCI detected in slot n indicates a row index that corresponds to a CG-COT-Sharing-r16 that provides channel occupancy sharing information, the gNB can share the UE channel occupancy assuming a channel access priority class p=channelAccessPriority-r16, starting from slot n+O, where O=offset-r16 slots, for a duration of D=duration-r16 slots where duration-r16, offset-r16, and channelAccessPriority-r16 are higher layer parameters provided by CG-COT-Sharing-r16.
If the higher layer parameter ul-toDL-COT-SharingED-Threshold-r16 is not provided, and if ‘COT sharing information’ in CG-UCI indicates ‘1’, the gNB can share the UE channel occupancy and start the DL transmission X=cg-COT-SharingOffset-r16 symbols from the end of the slot where CG-UCI is detected, where cg-COT-SharingOffset-r16 is provided by higher layer. The transmission shall not include any unicast transmissions with user plane data and the transmission duration is not more than the duration of 2, 4 and 8 symbols for subcarrier spacing of 15, 30 and 60 kHz of the corresponding channel, respectively.

In one embodiment, channel assess procedures based on semi-static channel occupancy as described in this Clause, are intended for environments where the absence of other technologies is guaranteed e.g., by level of regulations, private premises policies, etc. If a gNB provides UE(s) with higher layer parameters ChannelAccessMode-r16=‘semistatic’ by SIB1 or dedicated configuration, a periodic channel occupancy can be initiated by the gNB every Tₓ within every two consecutive radio frames, starting from the even indexed radio frame at i·Tₓx·Tₓ with a maximum channel occupancy time Ty=0.95Tx, where Tx=period Tx=Periodin ms, is a higher layer parameter provided in SemiStaticChannelAccessConfig and

$$i ∈ \{ 0 , 1 , … , \frac{20}{{T}_{x}} - 1 \} .$$

In the following procedures in this clause, when a gNB or UE performs sensing for evaluating a channel availability, the sensing is performed at least during a sensing slot duration Tₛₜ=9 us. The corresponding X_{Thresh} adjustment for performing sensing by a gNB or a UE is described in clauses 4.1.5 and 4.2.3, respectively.

A channel occupancy initiated by a gNB and shared with UE(s) shall satisfy the following:
The gNB shall transmit a DL transmission burst starting at the beginning of the channel occupancy time immediately after sensing the channel to be idle for at least a sensing slot duration Tₛₜ=9 us. If the channel is sensed to be busy, the gNB shall not perform any transmission during the current period.
The gNB may transmit a DL transmission burst(s) within the channel occupancy time immediately after sensing the channel to be idle for at least a sensing slot duration Tₛₜ=9 us if the gap between the DL transmission burst(s) and any previous transmission burst is more than 16 us.
The gNB may transmit DL transmission burst(s) after UL transmission burst(s) within the channel occupancy time without sensing the channel if the gap between the DL and UL transmission bursts is at most 16 us.
A UE may transmit UL transmission burst(s) after detection of a DL transmission burst(s) within the channel occupancy time as follows:
If the gap between the UL and DL transmission bursts is at most 16 us, the UE may transmit UL transmission burst(s) after a DL transmission burst(s) within the channel occupancy time without sensing the channel.
If the gap between the UL and DL transmission bursts is more than 16 us, the UE may transmit UL transmission burst(s) after a DL transmission burst(s) within the channel occupancy time after sensing the channel to be idle for at least a sensing slot duration Tₛₜ=9 us within a 25 us interval ending immediately before transmission.
The gNB and UEs shall not transmit any transmissions in a set of consecutive symbols for a duration of at least T_{z}=max(0.05Tₓ, 100 us) before the start of the next period.

If a UE fails to access the channel(s) prior to an intended UL transmission to a gNB, Layer 1 notifies higher layers about the channel access failure.

Regarding multi-PUSCH transmission, a single downlink control information (“DCI”) may schedule several transport blocks (“TBs”), referred to as multi-PUSCH transmission. According to TS 38.214 V16.5.0, if pusch-TimeDomainAllocationListForMultiPUSCH in pusch-Config contains a row indicating resource allocation for two to eight contiguous PUSCHs, K2 indicates the slot where UE shall transmit the first PUSCH of the multiple PUSCHs. Each PUSCH has a separate SLIV and mapping type. The number of scheduled PUSCHs is signaled by the number of indicated valid SLIVs in the row of the pusch-Time DomainAllocationListForMultiPUSCH signaled in DCI format 0_1.

Regarding PUSCH repetition type B, PUSCH repetition type B enables each repetition of a TB to be performed in contiguous symbols without any time gap. The number of nominal repetitions of a TB is indicated via DCI scheduling the TB repetitions. A “nominal repetition” can be divided into two or more “actual repetitions,” wherein there could be DL symbols and/or invalid symbols between the two adjacent actual repetitions of a nominal repetition.

Regarding PUSCH resource allocation in the time domain, when the UE is scheduled to transmit a transport block and no CSI report, or the UE is scheduled to transmit a transport block and a CSI report(s) on PUSCH by a DCI, the ‘Time domain resource assignment’ field value m of the DCI provides a row index m+1 to an allocated table. The determination of the used resource allocation table is defined in Clause 6.1.2.1.1. The indexed row defines the slot offset K₂, the start and length indicator SLIV, or directly the start symbol S and the allocation length L, the PUSCH mapping type, and the number of repetitions (if numberOfRepetitions is present in the resource allocation table) to be applied in the PUSCH transmission.

When the UE is scheduled to transmit a PUSCH with no transport block and with a CSI report(s) by a ‘CSI request’ field on a DCI, the ‘Time domain resource assignment’ field value m of the DCI provides a row index m+1 to the allocated table as defined in Clause 6.1.2.1.1. The indexed row defines the start and length indicator SLIV, or directly the start symbol S and the allocation length L, and the PUSCH mapping type to be applied in the PUSCH transmission and the K₂ value is determined as K₂=maxⱼYⱼ(m+1), where yⱼ,j=0, . . . , N_{Rep}−1 are the corresponding list entries of the higher layer parameter:
reportSlotOffsetListDCI-0-2, if PUSCH is scheduled by DCI format 0_2 and reportSlotOffsetListDCI-0-2 is configured;
reportSlotOffsetListDCI-0-1, if PUSCH is scheduled by DCI format 0_1 and reportSlotOffsetListDCI-0-1 is configured;
reportSlotOffsetList, otherwise:
   in CSI-ReportConfig for the N_{Rep} triggered CSI Reporting Settings and Yⱼ₍ₘ₊₁₎ is the (m+1)th entry of yⱼ.
The slot Ks where the UE shall transmit the PUSCH is determined by K₂ as

$${K}_{s} = ⌊ n \cdot \frac{{2}^{{μ}_{PUSCH}}}{{2}^{{μ}_{PDCCH}}} ⌋ + {K}_{2} + ⌊ ( \frac{{N}_{slot , offset , PDCCH}^{CA}}{{2}^{{μ}_{offset , PDCCH}}} - \frac{{N}_{slot , offset , PUSCH}^{CA}}{{2}^{{μ}_{offset , PUSCH}}} ) \cdot {2}^{{μ}_{PUSCH}} ⌋ ,$$

if UE is configured with ca-SlotOffset for at least one of the scheduled and scheduling cell,

$${K}_{s} = ⌊ n \cdot \frac{{2}^{{μ}_{PUSCH}}}{{2}^{{μ}_{PDCCH}}} ⌋ + {K}_{2} ,$$

otherwise, and where n is the slot with the scheduling DCI, K₂ is based on the numerology of PUSCH, and μ_{PUSCH} and μ_{PDCCH} are the subcarrier spacing configurations for PUSCH and PDCCH, respectively;
N_{slot,offset,PDCCH}^{CA} and μ_{offset,PDCCH} are the N_{slot,offset}^{CA} and the μ_{offset}, respectively, which are determined by higher-layer configured ca-SlotOffset for the cell receiving the PDCCH, N_{slot,offset,PUSCH}^{CA} and μ_{offset,PUSCH} are the N_{slot,offset}^{CA} and the μ_{offset}, respectively, which are determined by higher-layer configured ca-SlotOffset for the cell transmitting the PUSCH, as defined in clause 4.5 of TS 38.211, and
for PUSCH scheduled by DCI format 0_1, if pusch-RepTypeIndicatorDCI-0-1 is set to ‘pusch-RepTypeB’, the UE applies PUSCH repetition Type B procedure when determining the time domain resource allocation. For PUSCH scheduled by DCI format 0_2, if pusch-RepTypeIndicatorDCI-0-2 is set to ‘pusch-Rep TypeB’, the UE applies PUSCH repetition Type B procedure when determining the time domain resource allocation. Otherwise, the UE applies PUSCH repetition Type A procedure when determining the time domain resource allocation for PUSCH scheduled by PDCCH.

For PUSCH repetition Type A, the starting symbol S relative to the start of the slot, and the number of consecutive symbols L counting from the symbol S′ allocated for the PUSCH are determined from the start and length indicator SLIV of the indexed row:

```
if (L − 1) ≤ 7 then
  SLIV = 14 · (L − 1) + S
else
  SLIV = 14 · (14 − L + 1) + (14 − 1 − S)
where 0<L≤14−S, and
```

For PUSCH repetition Type B, the starting symbol S relative to the start of the slot, and the number of consecutive symbols L counting from the symbol S allocated for the PUSCH are provided by startSymbol and length of the indexed row of the resource allocation table, respectively.

For PUSCH repetition Type A, the PUSCH mapping type is set to Type A or Type B as defined in Clause 6.4.1.1.3 of TS 38.211 as given by the indexed row.

For PUSCH repetition Type B, the PUSCH mapping type is set to Type B.

The UE shall consider the S and L combinations defined in table 1 as valid PUSCH allocations:

TABLE 1
Valid S and L combinations

| PUSCH | Normal cyclic prefix | | | Extended cyclic prefix | | |
|---|---|---|---|---|---|---|
| mapping type | S | L | S + L | S | L | S + L |
| Type A | 0 | {4, . . . , | {4, . . . , | 0 | {4, . . . , | {4, . . . , |
| (repetition | | 14} | 14} | | 12} | 12} |
| Type A only) | | | | | | |
| Type B | {0, . . . , | {1, . . . , | {1, . . . , | {0, . . . , | {1, . . . , | {1, . . . , |
| | 13} | 14} | 14} for | 11} | 12} | 12} for |
| | | | repetition | | | repetition |
| | | | Type A, | | | Type A, |
| | | | {1, . . . , | | | {1, . . . , |
| | | | 27} for | | | 23} for |
| | | | repetition | | | repetition |
| | | | Type B | | | Type B |

For PUSCH repetition Type A, when transmitting PUSCH scheduled by DCI format 0_1 or 0_2 in PDCCH with CRC scrambled with C-RNTI, MCS-C-RNTI, or CS-RNTI with NDI=1, the number of repetitions K is determined as:
if numberOfRepetitions is present in the resource allocation table, the number of repetitions K is equal to numberOfRepetitions;
elseif the UE is configured with pusch-AggregationFactor, the number of repetitions K is equal to pusch-AggregationFactor;
otherwise K=1.

If a UE is configured with higher layer parameter pusch-TimeDomainAllocationListForMultiPUSCH, the UE does not expect to be configured with pusch-AggregationFactor.

For PUSCH repetition Type A, in case K>1, the same symbol allocation is applied across the K consecutive slots and the PUSCH is limited to a single transmission layer. The UE shall repeat the TB across the K consecutive slots applying the same symbol allocation in each slot. The redundancy version to be applied on the nth transmission occasion of the TB, where n=0, 1, . . . K−1, is determined according to Table 2.

TABLE 2
Redundancy version for PUSCH transmission

| rv_{id} indicated | rv_{id} to be applied to n^{th} transmission occasion (repetition | | | |
|---|---|---|---|---|
| by the DCI | Type A) or n^{th} actual repetition (repetition Type B) | | | |
| scheduling the | n mod | n mod | n mod | n mod |
| PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

When transmitting MsgA PUSCH on a non-initial UL BWP, if the UE is configured with startSymbolAndLengthMsgA-PO, the UE shall determine the S and L from startSymbolAndLengthMsgA-PO.

When transmitting MsgA PUSCH, if the UE is not configured with startSymbolAndLengthMsgA-PO, and if the TDRA list PUSCH-TimeDomainResourceAllocationList is provided in PUSCH-ConfigCommon, the UE shall use msgA-PUSCH-TimeDomainAllocation to indicate which values are used in the list. If PUSCH-Time DomainResourceAllocationList is not provided in PUSCH-ConfigCommon, the UE shall use parameters S and L from table 4 or table 5 where msgA-PUSCH-TimeDomainAllocation indicates which values are used in the list. The time offset for PUSCH transmission is described in TS38.213.

For PUSCH repetition Type A, a PUSCH transmission in a slot of a multi-slot PUSCH transmission is omitted according to the conditions in Clause 9, Clause 11.1 and Clause 11.2A of TS38.213.

For PUSCH repetition Type B, except for PUSCH transmitting CSI report(s) with no transport block, the number of nominal repetitions is given by numberOfRepetitions. For the n-th nominal repetition, n=0, . . . , numberOfRepetitions−1,
The slot where the nominal repetition starts is given by

$${K}_{s} + ⌊ \frac{S + n \cdot L}{{N}_{symb}^{slot}} ⌋ ,$$

and the starting symbol relative to the start of the slot is given by mod (S+n·L,N_{symb}^{slot}).
The slot where the nominal repetition ends is given by

$${K}_{s} + ⌊ \frac{S + ( n + 1 ) \cdot L - 1}{{N}_{symb}^{slot}} ⌋ ,$$

and the ending symbol relative to the start of the slot is given by mod(S+(n+1)·L−1,N_{symb}^{slot}).

Here K, is the slot where the PUSCH transmission starts, and N_{symb}^{slot} is the number of symbols per slot as defined in Clause 4.3.2 of TS38.211.

For PUSCH repetition Type B, the UE determines invalid symbol(s) for PUSCH repetition Type B transmission as follows:
A symbol that is indicated as downlink by tdd-UL-DL-ConfigurationCommon or tdd-UL-DL-ConfigurationDedicated is considered as an invalid symbol for PUSCH repetition Type B transmission.
For operation in unpaired spectrum, symbols indicated by ssb-PositionsInBurst in SIB1 or ssb-PositionsInBurst in ServingCellConfigCommon for reception of SS/PBCH blocks are considered as invalid symbols for PUSCH repetition Type B transmission.
For operation in unpaired spectrum, symbol(s) indicated by pdcch-ConfigSIBI in MIB for a CORESET for Type0-PDCCH CSS set are considered as invalid symbol(s) for PUSCH repetition Type B transmission.
For operation in unpaired spectrum, if numberOfInvalidSymbolsForDL-UL-Switching is configured, numberOfInvalidSymbolsForDL-UL-Switching symbol(s) after the last symbol that is indicated as downlink in each consecutive set of all symbols that are indicated as downlink by tdd-UL-DL-ConfigurationCommon or tdd-UL-DL-ConfigurationDedicated are considered as invalid symbol(s) for PUSCH repetition Type B transmission. The symbol(s) given by numberOfInvalidSymbolsForDL-UL-Switching are defined using the reference SCS configuration referenceSubcarrierSpacing provided in tdd-UL-DL-ConfigurationCommon.
The UE may be configured with the higher layer parameter invalidSymbolPattern, which provides a symbol level bitmap spanning one or two slots (higher layer parameter symbols given by invalidSymbolPattern). A bit value equal to 1 in the symbol level bitmap symbols indicates that the corresponding symbol is an invalid symbol for PUSCH repetition Type B transmission. The UE may be additionally configured with a time-domain pattern (higher layer parameter periodicityAndPattern given by invalidSymbolPattern), where each bit of periodicityAndPattern corresponds to a unit equal to a duration of the symbol level bitmap symbols, and a bit value equal to 1 indicates that the symbol level bitmap symbols is present in the unit. The periodicityAndPattern can be {1, 2, 4, 5, 8, 10, 20 or 40} units long, but maximum of 40 msec. The first symbol of periodicityAndPattern every 40 msec/P periods is a first symbol in frame n_{f} mod 4=0, where P is the duration of periodicityAndPattern-r16 in units of msec. When periodicityAndPattern is not configured, for a symbol level bitmap spanning two slots, the bits of the first and second slots correspond respectively to even and odd slots of a radio frame, and for a symbol level bitmap spanning one slot, the bits of the slot correspond to every slot of a radio frame. If invalidSymbolPattern is configured, when the UE applies the invalid symbol pattern is determined as follows:
if the PUSCH is scheduled by DCI format 0_1, or corresponds to a Type 2 configured grant activated by DCI format 0_1, and if invalidSymbolPatternIndicatorDCI-0-1 is configured,
if invalid symbol pattern indicator field is set 1, the UE applies the invalid symbol pattern;
otherwise, the UE does not apply the invalid symbol pattern;
if the PUSCH is scheduled by DCI format 0_2, or corresponds to a Type 2 configured grant activated by DCI format 0_2, and if invalidSymbolPatternIndicatorDCI-0-2 is configured,
if invalid symbol pattern indicator field is set 1, the UE applies the invalid symbol pattern;
otherwise, the UE does not apply the invalid symbol pattern;
otherwise, the UE applies the invalid symbol pattern.
If the UE
is configured with multiple serving cells and is provided half-duplex-behavior=‘enable’, and
is not capable of simultaneous transmission and reception on any of the multiple serving cells, and
indicates support of capability for half-duplex operation in CA with unpaired spectrum, and
is not configured to monitor PDCCH for detection of DCI format 2-0 on any of the multiple serving cells,
a symbol is considered as an invalid symbol in any of the multiple serving cells for PUSCH repetition Type B transmission if the symbol is indicated to the UE for reception of SS/PBCH blocks in any of the multiple serving cells by ssb-PositionsInBurst in SIB1 or ssb-PositionsInBurst in ServingCellConfigCommon, and
a symbol is considered as an invalid symbol in any of the multiple serving cells for PUSCH repetition Type B transmission with Type 1 or Type 2 configured grant except for the first Type 2 PUSCH transmission (including all repetitions) after activation if the symbol is indicated as downlink by tdd-UL-DL-ConfigurationCommon or tdd-UL-DL-ConfigurationDedicated on the reference cell, or the UE is configured by higher layers to receive PDCCH, PDSCH, or CSI-RS on the reference cell in the symbol.

For PUSCH repetition Type B, after determining the invalid symbol(s) for PUSCH repetition type B transmission for each of the K nominal repetitions, the remaining symbols are considered as potentially valid symbols for PUSCH repetition Type B transmission. If the number of potentially valid symbols for PUSCH repetition type B transmission is greater than zero for a nominal repetition, the nominal repetition consists of one or more actual repetitions, where each actual repetition consists of a consecutive set of all potentially valid symbols that can be used for PUSCH repetition Type B transmission within a slot. An actual repetition with a single symbol is omitted except for the case of L=1. An actual repetition is omitted according to the conditions in Clause 9, Clause 11.1 and Clause 11.2A of TS38.213. The redundancy version to be applied on the nth actual repetition (with the counting including the actual repetitions that are omitted) is determined according to table 6.1.2.1-2.

For PUSCH repetition Type B, when a UE receives a DCI that schedules aperiodic CSI report(s) or activates semi-persistent CSI report(s) on PUSCH with no transport block by a ‘CSI request’ field on a DCI, the number of nominal repetitions is always assumed to be 1, regardless of the value of numberOfRepetitions. When the UE is scheduled to transmit a PUSCH repetition Type B with no transport block and with aperiodic or semi-persistent CSI report(s) by a ‘CSI request’ field on a DCI, the first nominal repetition is expected to be the same as the first actual repetition. For PUSCH repetition Type B carrying semi-persistent CSI report(s) without a corresponding PDCCH after being activated on PUSCH by a ‘CSI request’ field on a DCI, if the first nominal repetition is not the same as the first actual repetition, the first nominal repetition is omitted: otherwise, the first nominal repetition is omitted according to the conditions in Clause 9, Clause 11.1 and Clause 11.2A of TS38.213.

For PUSCH repetition Type B, when a UE is scheduled to transmit a transport block and aperiodic CSI report(s) on PUSCH by a ‘CSI request’ field on a DCI, the CSI report(s) is multiplexed only on the first actual repetition. The UE does not expect that the first actual repetition has a single symbol duration.

If pusch-TimeDomainAllocationListForMultiPUSCH in pusch-Config contains row indicating resource allocation for two to eight contiguous PUSCHs, K₂ indicates the slot where UE shall transmit the first PUSCH of the multiple PUSCHs. Each PUSCH has a separate SLIV and mapping type. The number of scheduled PUSCHs is signalled by the number of indicated valid SLIVs in the row of the pusch-TimeDomainAllocationListForMultiPUSCH signalled in DCI format 0_1.

When the UE is configured with minimumSchedulingOffsetK2 in an active UL BWP it applies a minimum scheduling offset restriction indicated by the ‘Minimum applicable scheduling offset indicator’ field in DCI format 0_1 or DCI format 1_1 if the same field is available. When the UE configured with minimumSchedulingOffsetK2 in an active UL BWP and it has not received ‘Minimum applicable scheduling offset indicator’ field in DCI format 0_1 or 1_1, the UE shall apply a minimum scheduling offset restriction indicated based on ‘Minimum applicable scheduling offset indicator’ value ‘0’. When the minimum scheduling offset restriction is applied the UE is not expected to be scheduled with a DCI in slot n to transmit a PUSCH scheduled with C-RNTI, CS-RNTI, MCS-C-RNTI or SP-CSI-RNTI with K₂ smaller than

$$⌈ {K}_{2 min} \cdot \frac{{2}^{{μ}^{′}}}{{2}^{μ}} ⌉ ,$$

where K₂ₘᵢₙ and μ are the applied minimum scheduling offset restriction and the numerology of the active UL BWP of the scheduled cell when receiving the DCI in slot n, respectively, and μ′ is the numerology of the new active UL BWP in case of active UL BWP change in the scheduled cell and is equal to μ, otherwise. The minimum scheduling offset restriction is not applied when PUSCH transmission is scheduled by RAR UL grant or fallbackRAR UL grant for RACH procedure, or when PUSCH is scheduled with TC-RNTI. The application delay of the change of the minimum scheduling offset restriction is determined in Clause 5.3.1.

Regarding determination of the resource allocation table to be used for PUSCH, Table 3, Table 3A and Table 3B define which PUSCH time domain resource allocation configuration to apply.

Table 6 defines the subcarrier spacing specific values j. j is used in determination of K₂ in conjunction to table 4, for normal CP or table 6.1.2.1.1.-3 for extended CP, where μ_{PUSCH} is the subcarrier spacing configurations for PUSCH.

Table 7 defines the additional subcarrier spacing specific slot delay value for the first transmission of PUSCH scheduled by the RAR or by the fallbackRAR. When the UE transmits a PUSCH scheduled by RAR or by the fallbackRAR, the Δ value specific to the PUSCH subcarrier spacing μ_{PUSCH} is applied in addition to the K₂ value.

TABLE 3
Applicable PUSCH time domain resource allocation for common
search space and DCI format 0_0 in UE specific search space

| | PDCCH | pusch-ConfigCommon | pusch-Config includes | PUSCH time domain |
|---|---|---|---|---|
| | search | includes pusch- | pusch- | resource allocation to |
| RNTI | space | TimeDomainAllocationList | TimeDomainAllocationList | apply |
| PUSCH scheduled | | No | — | Default A |
| by MAC RAR as | | Yes | | pusch- |
| described in clause | | | | Time DomainAllocationList |
| 8.2 of TS 38.213 or | | | | provided in pusch- |
| MAC fallbackRAR | | | | ConfigCommon |
| as described in | | | | |
| clause 8.2A of | | | | |
| 38.213 or for MsgA | | | | |
| PUSCH | | | | |
| transmission | | | | |
| C- | Any | No | — | Default A |
| RNTI, | common | Yes | | pusch- |
| MCS- | search | | | TimeDomainAllocationList |
| C- | space | | | provided in pusch- |
| RNTI, | associated | | | ConfigCommon |
| TC- | with | | | |
| RNTI, | CORESET | | | |
| CS- | 0 | | | |
| RNTI | | | | |
| C- | Any | No | No | Default A |
| RNTI, | common | Yes | No | pusch- |
| MCS- | search | | | TimeDomainAllocationList |
| C- | space not | | | provided in pusch- |
| RNTI, | associated | | | ConfigCommon |
| TC- | with | No/Yes | Yes | pusch- |
| RNTI, | CORESET | | | TimeDomainAllocationList |
| CS- | 0, | | | provided in pusch-Config |
| RNTI, | DCI | | | |
| SP- | format 0_0 | | | |
| CSI- | in | | | |
| RNTI | UE | | | |
| | specific | | | |
| | search | | | |
| | space | | | |

TABLE 3A
Applicable PUSCH time domain resource allocation for DCI format 0_1 in UE
specific search space scrambled with C-RNTI, MCS-C-RNTI, CS-RNTI or SP-CSI-RNTI

| pusch- | | | pusch-Config | |
|---|---|---|---|---|
| ConfigCommon | pusch-Config | pusch-Config | includes pusch- | PUSCH time |
| includes pusch- | includes pusch- | includes pusch- | TimeDomainAllo- | domain resource |
| TimeDomainAllo- | TimeDomainAllo- | TimeDomainAllo- | cationList- | allocation |
| cationList | cationList | cationListDCI-0-1 | ForMultiPUSCH | to apply |
| No | No | No | No | Default A |
| Yes | No | No | No | pusch- |
| | | | | TimeDomainAllocationList |
| | | | | provided in |
| | | | | pusch- |
| | | | | ConfigCommon |
| No/Yes | Yes | No | No | pusch- |
| | | | | TimeDomainAllocationList |
| | | | | provided in |
| | | | | pusch-Config |
| No/Yes | No/Yes | Yes | — | pusch- |
| | | | | TimeDomainAllocationListDCI-0-1 |
| | | | | provided in pusch- |
| | | | | Config |
| No/Yes | No/Yes | — | Yes | pusch- |
| | | | | TimeDomainAllocationList- |
| | | | | ForMultiPUSCH |
| | | | | provided in pusch- |
| | | | | Config |

TABLE 3B
Applicable PUSCH time domain resource allocation for DCI format 0_2 in UE
specific search space scrambled with C-RNTI, MCS-C-RNTI, CS-RNTI or SP-CSI-RNTI

| pusch- | | | |
|---|---|---|---|
| ConfigCommon | pusch-Config | pusch-Config includes | PUSCH time domain |
| includes pusch- | includes pusch- | pusch- | resource allocation to |
| TimeDomainAllocationList | TimeDomainAllocationList | TimeDomainAllocationListDCI-0-2 | apply |
| No | No | No | Default A |
| Yes | No | No | pusch- |
| | | | TimeDomainAllocationList |
| | | | provided in pusch- |
| | | | ConfigCommon |
| No/Yes | Yes | No | pusch- |
| | | | TimeDomainAllocationList |
| | | | provided in pusch- |
| | | | Config |
| No/Yes | No/Yes | Yes | pusch- |
| | | | TimeDomainAllocationListDCI-0-2 |
| | | | provided in |
| | | | pusch-Config |

TABLE 4
Default PUSCH time domain resource allocation A for normal CP

| Row index | PUSCH mapping type | K₂ | S | L |
|---|---|---|---|---|
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

TABLE 5
Default PUSCH time domain resource
allocation A for extended CP

| Row index | PUSCH mapping type | K₂ | S | L |
|---|---|---|---|---|
| 1 | Type A | j | 0 | 8 |
| 2 | Type A | j | 0 | 12 |
| 3 | Type A | j | 0 | 10 |
| 4 | Type B | j | 2 | 10 |
| 5 | Type B | j | 4 | 4 |
| 6 | Type B | j | 4 | 8 |
| 7 | Type B | j | 4 | 6 |
| 8 | Type A | j + 1 | 0 | 8 |
| 9 | Type A | j + 1 | 0 | 12 |
| 10 | Type A | j + 1 | 0 | 10 |
| 11 | Type A | j + 2 | 0 | 6 |
| 12 | Type A | j + 2 | 0 | 12 |
| 13 | Type A | j + 2 | 0 | 10 |
| 14 | Type B | j | 8 | 4 |
| 15 | Type A | j + 3 | 0 | 8 |
| 16 | Type A | j + 3 | 0 | 10 |

TABLE 6
Definition of value j

| μ_{PUSCH} | j |
|---|---|
| 0 | 1 |
| 1 | 1 |
| 2 | 2 |
| 3 | 3 |

TABLE 7
Definition of value Δ

| μ_{PUSCH} | Δ |
|---|---|
| 0 | 2 |
| 1 | 3 |
| 2 | 4 |
| 3 | 6 |

Regarding COT initiator determination for G transmissions, in one embodiment, when a configured UL transmission starts after a UE FFP boundary and ends before the idle period of that UE FFP associated to the UE, if the UE has already initiated the UE FFP, then the UE assumes that the configured UL transmission corresponds to UE-initiated COT: otherwise, if the transmission is confined within a gNB FFP before the idle period of that gNB FFP, and if the UE has already determined that gNB has initiated that gNB FFP, then UE assumes that the configured UL transmission corresponds to gNB-initiated COT.

The solutions described herein provide mechanisms to determine the COT initiator for each PUSCH transmission of a multi-PUSCH transmission or for each repetition of PUSCH repetitions, wherein the multiple PUSCH transmissions or repetitions are scheduled by a single DCI.

It should be noted that throughout the disclosure, the terms symbol/slot/subslot/transmission time interval (“TTI”) can be a time unit with a particular duration (e.g., symbol could be a fraction/percentage of an orthogonal frequency division multiplexing (“OFDM”) symbol length associated with a particular subcarrier spacing (“SCS”)).

In the following embodiments and implementations, sharing a COT implies that the device or node with which the COT is shared can forego an indicated or configured channel access category/type for channel sensing and instead apply/perform a channel access according to a category/type whose characteristic includes a generally shorter sensing period, an increased likelihood for the channel sensing to result in being able to transmit, or no required sensing period prior to transmission in the shared COT.

Throughout this disclosure, u-FFP refers to a UE-FFP (an FFP associated/configured for UE-initiated COT), g-FFP refers to a gNB-FFP (an FFP associated/configured for gNB-initiated COT), PUSCH-g refers to a PUSCH transmission that is sent based on a gNB being a COT initiator, and PUSCH-u refers to a PUSCH transmission that is sent based on a UE being a COT initiator.

Some benefits of having a different COT initiator for different PUSCH transmissions/repetitions are represented in FIGS. 3-5.

FIG. 3 depicts a DCI 302 that schedules PUSCH-g 304 and PUSCH-u 306. In one embodiment, gNB has initiated a COT in G-FFP1 308 (e.g., to serve other UEs or to schedule the UE). In one embodiment, the UE has not initiated a COT in U-FFP1 310. In one embodiment, PUSCH-g 304 is not aligned with a u-FFP boundary and transmitted based on gNB as COT initiator. In one embodiment, PUSCH-u 306 can be sent during g-idle 312 (if COT initiator for PUSCH-u 306 is indicated to be the UE) as the gNB does not have any other data to initiate a g-COT in G-FFP2 314. In one embodiment, g-idle 312 may be longer than u-idle 316 and/or the overlap of g-idle 312 and PUSCH-u 306 may also be longer than the overlap of PUSCH-g 304 and u-idle 316. In one embodiment, an LBT/gap may be required between PUSCH-g 304 and PUSCH-u 306 of the UE (e.g., PUSCH-g 304 ends (or PUSCH-g 304 symbols overlapping with u-idle 316 are considered as invalid symbols) prior to u-idle 316).

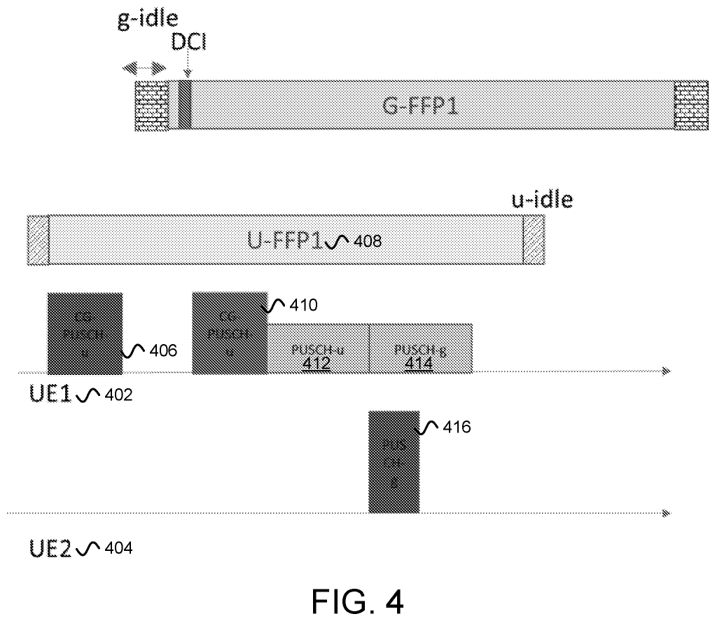

FIG. 4 depicts a scenario where, in one embodiment, UE1 402 has already initiated a COT due to a 1^{st} configured grant (“CG”)-PUSCH 406 transmission (e.g., as CG-PUSCH is aligned with U-FFP1 408 boundary). In one embodiment, gNB knows there is a 2^{nd} CG-PUSCH 410 coming up and would like to schedule UL transmission right after the 2^{nd} CG-PUSCH 410. In one embodiment, the 2^{nd} CG-PUSCH 410 is sent according to UE-COT (e.g., based on the agreed UE behavior for determining the COT initiator in case of CG transmissions, as explained above), and transmitting PUSCH-u 412 according to UE-COT could avoid LBT prior to PUSCH-u 412 transmission; whereas LBT may be required if PUSCH-u 412 is instead a PUSCH-g 414 as it has to be transmitted assuming g-COT. In one embodiment, gNB wants to schedule a PUSCH 416 for UE2 404. To be able to do that, PUSCH-g 414 for UE1 402 needs to be sent assuming g-COT. In one embodiment, an LBT/gap may be required between PUSCH-u 412 and PUSCH-g 414 of UE1 402.

In an embodiment, if a UE receives an indication from a network entity (e.g. gNB) to perform an UL transmission to the network entity (e.g. PUCCH or PUSCH transmission indicated by DCI), where the UL transmission would occur within a UE-initiated COT (i.e. the COT initiated by the UE) and yet the UL transmission is indicated to be performed according to a network entity-initiated COT, the UE considers that the remaining UE-initiated COT duration is not valid and performs the UL transmission according to the network entity-initiated COT. In an example, if the UL transmission indicated by the network entity overlaps with an idle period of UE's FFP, the UE performs the UL transmission during the idle period of UE's FFP, as long as the idle period of UE's FFP does not overlap with an idle period of network entity's FFP. In an implementation, the invalid remaining UE-initiated COT duration starts from X symbols after the last symbol of a PDCCH, where the UE detects a DCI format indicating the UL transmission.

In an embodiment, if a UE receives an indication from a network entity to perform a plurality of UL transmissions to the network entity (e.g., multiple PUCCH or PUSCH transmissions or PUCCH/PUSCH repetitions indicated by one DCI), where a subset of UL transmissions would occur within a UE-initiated COT (e.g., the COT that has already been initiated by the UE) and yet the subset of UL transmissions is indicated to be performed according to a network entity-initiated COT, as shown in FIG. 4, the UE considers that the remaining UE-initiated COT duration starting from the earliest symbol of the subset of UL transmissions is not valid and performs the subset of UL transmissions according to the network entity-initiated COT.

In an embodiment, if a UE receives an indication from a network entity to perform a plurality of UL transmissions to the network entity (e.g., multiple PUCCH or PUSCH transmissions or PUCCH/PUSCH repetitions indicated by one DCI), where a subset of UL transmissions would occur within UE's FFP and is indicated to be performed according to a UE-initiated COT, as shown in FIG. 3, the UE considers that a remaining network entity-initiated COT duration starting from the earliest symbol of the subset of UL transmissions is not valid, initiates a UE COT according to UE's FFP configuration, and performs the subset of UL transmissions based on the UE-initiated COT. In an example, the UE performs the subset of UL transmissions during the idle period of network entity's FFP, as long as the idle period of network entity's FFP does not overlap with an idle period of UE's FFP.

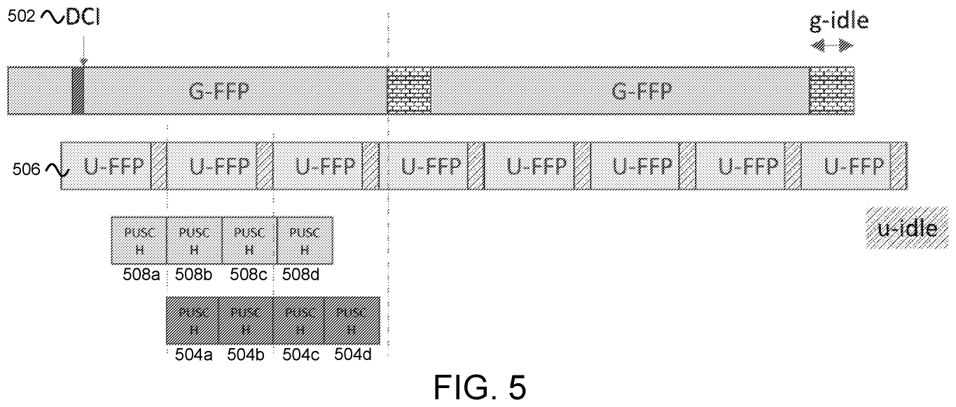

Regarding Multi-PUSCH transmission, two examples of multi-PUSCH transmissions are shown in FIG. 5. FIG. 5 depicts a multi-PUSCH transmission scheduled by the DCI 502. The 1st transmission of a first multi-PUSCH transmission 504a starts from a U-FFP 506 boundary whereas the 1st transmission of a second multi-PUSCH transmission 508a does not start from a U-FFP 506 boundary. In an example, the 1st transmission of a first multi-PUSCH transmission 504a can be transmitted based on a UE-initiated COT and the remaining PUSCHs 540a-c can be sent based on gNB-initiated COT. In another example, all of the PUSCHs 508a-d of the second multi-PUSCH transmission can be based on gNB-initiated COT.

In an embodiment, multi-PUSCH time-domain allocation table (a TDRA table) is extended to have a field/column indicating whether the UE or gNB is the COT initiator for each PUSCH of the multi-PUSCH. In an implementation, pusch-TimeDomainAllocationListForMultiPUSCH is extended with an individual COT initiator indicator for each PUSCH. In an alternative embodiment, all the PUSCHs of the multi-PUSCH transmission (scheduled via a single scheduling DCI) have the same COT initiator indicated in the scheduling DCI. In another embodiment, the contiguous PUSCHs without gap between PUSCHs of the multi-PUSCH transmission have the same COT initiator. In another embodiment, a first number of consecutive PUSCHs or contiguous PUSCHs without a gap between PUSCHs have the same COT initiator (1st COT initiator) and the rest of the consecutive PUSCHs or contiguous PUSCHs without a gap between PUSCHs have the same COT initiator (2nd COT initiator). In an example, the first number is indicated as a field/column of the multi-PUSCH time-domain allocation table. In another example, the 1^{st} COT initiator is the UE. In another example, a row of the table includes the first number. In one embodiment, the UE determines the COT initiator to be the UE for the first number of consecutive PUSCH transmissions and the gNB for the remaining number of consecutive PUSCH transmissions. In another example, the first number of consecutive PUSCHs occupies the same FFP (e.g., gNB FFP or UE FFP). In an example, the first number of PUSCHs starts from the first PUSCH after reception of the scheduling DCI.

In one embodiment, a field in the scheduling DCI indicates the COT initiator, wherein the indication is only applicable to a 1^{st} number of scheduled PUSCH transmissions out of the total number of PUSCH transmissions scheduled by the DCI. In an example, the indication is only applicable to the first PUSCH transmission. In another example, the COT initiator for each of the rest of transmissions is determined based on rules defined for determining the COT initiator for a configured grant UL transmission. In another example, the first number of consecutive PUSCHs occupies the same FFP (e.g., gNB FFP or UE FFP). In another example, the indicated COT initiator applies until the COT initiator's FFP boundary. In one example, a 2nd DCI indicates the COT initiator for PUSCHs (of the multi-PSUCH) beyond the COT initiator's FFP boundary. In an example, the COT initiator indicated in the second DCI (referred to as 2nd COT initiator) applies until the 2nd COT initiator's FFP boundary. In an example, the COT initiator for the rest of transmissions is determined based on rules defined for determining the COT initiator for a configured grant UL transmission.

In one embodiment, the COT initiator indication in the scheduling DCI is only applicable to PUSCH transmissions within a predetermined window. In an example, the predetermined window is a time window starting from a reference time point such as the last symbol of the scheduling DCI PDCCH or an offset time with respect to the last symbol of the scheduling DCI PDCCH. In one embodiment, the offset can be determined based on UE capability signaling (such as PUSCH processing capability), or based on RRC signaling, or based on a fixed value in the specifications. In one embodiment, the time window can start from and/or end at the boundary of an upcoming u-FFP or g-FFP. In one embodiment, the duration of the predetermined window can be RRC signaled, signaled in the scheduling DCI (e.g., in number of time units such as symbols, slots, u-FFP, g-FFP, etc.), or the remaining duration of UE-FFP or gNB-FFP.

In one embodiment, a 1st number of consecutive/contiguous PUSCH transmissions of the multi-PUSCH has a 1st COT initiator and the remaining number of consecutive/contiguous PUSCH transmissions of the multi-PUSCH have a 2nd COT initiator. In one embodiment, the UE is not expected to receive a scheduling DCI indicating a 1st number of consecutive/contiguous PUSCH transmissions of the multi-PUSCH has a 1st COT initiator and a next 2nd number of consecutive/contiguous PUSCH transmissions of the multi-PUSCH has a 2nd COT initiator, and a next 3rd number of consecutive/contiguous PUSCH transmissions of the multi-PUSCH has the 1st COT initiator. In one embodiment, this may mandate an additional LBT. In an example, the UE is not expected to perform more than ‘X’ LBTs within transmission duration of a multi-PUSCH transmission. ‘X’ can be specified in 3GPP specifications or can be a UE capability.

In one embodiment, the UE maintains a gap and/or performs LBT between each pair of PUSCH transmissions of the multi-PUSCH if the COT initiator is different for the pair of PUSCH transmissions, e.g., at least for the case that the 1st PUSCH of the pair is transmitted according to g-COT and the latter PUSCH of the pair is transmitted according to the u-COT. In an example, the latter PUSCH is aligned with a u-FFP boundary. In another example, (a) the symbols overlapping with u-idle are considered invalid symbols for the PUSCH-g if the next PUSCH of the multi-PUSCH is a PUSCH-u and/or (b) the symbols overlapping with g-idle are considered invalid symbols for the PUSCH-u if the next PUSCH of the multi-PUSCH is a PUSCH-g. If a symbol is considered invalid, no transmission is performed. This may result in a transmission of PUSCH-u/PUSCH-g only on those symbols that are not considered invalid, i.e. a partial PUSCH-u/PUSCH-g transmission. In an example, the remaining symbols of a PUSCH which has invalid symbols due to overlapping with u-idle or g-idle are (a) dropped or (b) considered as new actual repetition in case PUSCH repetition type B is configured/supported.

In one embodiment, the DCI field indicating the COT initiator for the PUSCH transmissions has a predetermined field size. The field size may be determined based on one or more of the maximum number of contiguous/consecutive PUSCHs (e.g., 8) or having the field size fixed/configured, e.g., X bits, and having scheduled PUSCHs grouped in X groups. For instance, if X=4 bits, and 8 contiguous PUSCHs scheduled, every two consecutive PUSCHs have the same COT initiator—the COT initiator for the 1st two PUSCHs is determined based on the 1st bit of the 4-bit field and the COT initiator for the 2nd two PUSCHs is determined based on the 2nd bit of the 4-bit field, and so on.

In one embodiment, a first PUSCH transmission and a second PUSCH transmission of the multi-PUSCH transmissions can have different COT initiators if the first PUSCH transmission overlaps with the u-FFP idle and the second PUSCH transmission overlaps with the g-FFP idle (see FIG. 3).

In one embodiment, a 2nd DCI can be sent to update the COT initiator for a remaining of the multiple PUSCHs. The 2nd DCI may have a characteristic such as a field indicating whether this DCI is updating the COT initiator assumption for the already scheduled PUSCHs. In one embodiment, the 2nd DCI can update COT initiator assumption for a subset of the PUSCH transmissions of the multi-PUSCH transmission that are at least certain time (e.g., N2 symbols) after the 2nd DCI. In one embodiment, the 2nd DCI may be a group-common PDCCH. The UE may be configured with a position in DCI field and possibly a number of bits for determining the updated COT initiator field in the 2nd DCI.

Regarding PUSCH repetition, the methods and embodiments for COT initiator determination of multi-PUSCH can be used to determine the COT initiator of repetitions of PUSCH repetition (e.g., type B), e.g., instead of a first PUSCH and a second PUSCH of the multi-PUSCH, a first repetition and a second repetition of the PUSCH repetition can be used.

In one embodiment, a field in the scheduling DCI indicates the COT initiator for each (or a first number of) nominal repetition(s). Alternatively, a field in the scheduling DCI indicates the COT initiator for each (or a first number of) actual repetition(s).

In an embodiment, actual PUSCH repetitions associated to a nominal PUSCH repetition have the same COT initiator. The UE can determine the same COT initiator for actual PUSCH repetitions associated to a nominal PUSCH repetition.

In some embodiments, when a DCI can schedule both multiple PUSCHs and corresponding repetitions, then COT initiator can be determined as (1) at least two set of COT initiator indications are signaled (via TDRA or a DCI field), wherein the first set of COT initiator indication is applied to multiple PUSCH transmissions and the second set of COT initiator indication is applied to corresponding PUSCH repetitions: (2) for a first PUSCH transmission and its repetitions, one COT initiator indication is applied, for a second PUSCH transmission and its repetitions, second COT initiator indication is applied, and so on; and/or (3) for a first PUSCH transmission, one COT initiator indication is applied and for its first repetition a second COT initiator indication is applied, for a second repetition of the first PUSCH transmission a third COT initiator indication is applied, and so on. Similarly, for following PUSCH transmissions and corresponding repetitions.

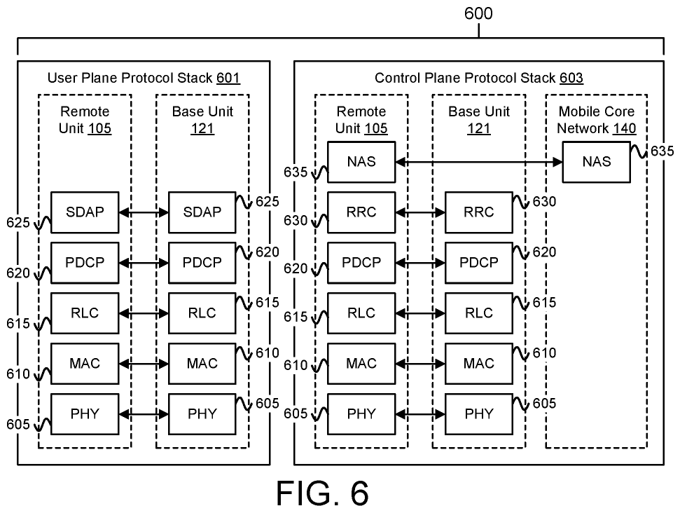

FIG. 6 depicts a NR protocol stack 600, according to embodiments of the disclosure. While FIG. 6 shows the remote unit 105, the base unit 121 and the mobile core network 130, these are representative of a set of UEs interacting with a RAN node and a NF (e.g., AMF) in a core network. As depicted, the protocol stack 600 comprises a User Plane protocol stack 601 and a Control Plane protocol stack 603. The User Plane protocol stack 601 includes a physical (“PHY”) layer 605, a Medium Access Control (“MAC”) sublayer 610, a Radio Link Control (“RLC”) sublayer 615, a Packet Data Convergence Protocol (“PDCP”) sublayer 620, and Service Data Adaptation Protocol (“SDAP”) layer 625. The Control Plane protocol stack 603 also includes a physical layer 605, a MAC sublayer 610, a RLC sublayer 615, and a PDCP sublayer 620. The Control Place protocol stack 603 also includes a Radio Resource Control (“RRC”) layer 630 and a Non-Access Stratum (“NAS”) layer 635.

The AS protocol stack for the Control Plane protocol stack 603 consists of at least RRC, PDCP, RLC and MAC sublayers, and the physical layer. The AS protocol stack for the User Plane protocol stack 601 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 630 and the NAS layer 635 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 605 offers transport channels to the MAC sublayer 610. The MAC sublayer 610 offers logical channels to the RLC sublayer 615. The RLC sublayer 615 offers RLC channels to the PDCP sublayer 620. The PDCP sublayer 620 offers radio bearers to the SDAP sublayer 625 and/or RRC layer 630. The SDAP sublayer 625 offers QoS flows to the mobile core network 130 (e.g., 5GC). The RRC layer 630 provides for the addition, modification, and release of Carrier Aggregation and/or Dual Connectivity. The RRC layer 630 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

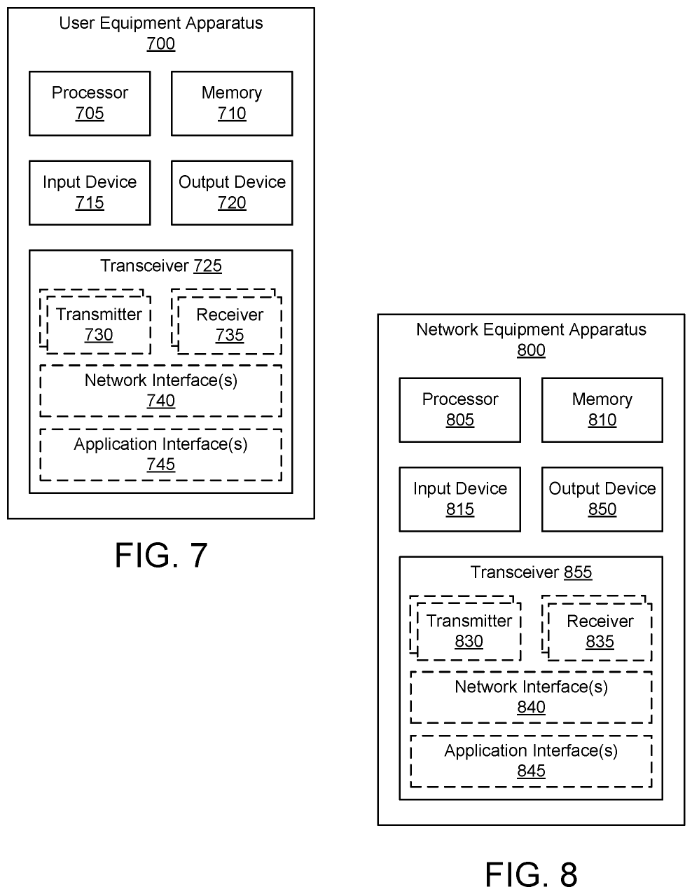

FIG. 7 depicts a user equipment apparatus 700 that may be used for channel occupancy initiator determination for transmissions in unlicensed spectrum, according to embodiments of the disclosure. In various embodiments, the user equipment apparatus 700 is used to implement one or more of the solutions described above. The user equipment apparatus 700 may be one embodiment of a UE, such as the remote unit 105 and/or the UE 205, as described above. Furthermore, the user equipment apparatus 700 may include a processor 705, a memory 710, an input device 715, an output device 720, and a transceiver 725. In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more base units 121. Additionally, the transceiver 725 may support at least one network interface 740 and/or application interface 745. The application interface(s) 745 may support one or more APIs. The network interface(s) 740 may support 3GPP reference points, such as Uu and PC5. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to CSI enhancements for higher frequencies. For example, the memory 710 may store parameters, configurations, resource assignments, policies, and the like as described above. In certain embodiments, the memory 710 also stores program code and related data, such as an operating system or other controller algorithms operating on the user equipment apparatus 700, and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. The transceiver 725 may be used to provide UL communication signals to a base unit 121 and to receive DL communication signals from the base unit 121, as described herein. Similarly, the transceiver 725 may be used to transmit and receive SL signals (e.g., V2X communication), as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an ASIC, or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

In one embodiment, the transceiver 725 receives a scheduling downlink control information (“DCI”) for scheduling a set of physical uplink shared channel (“PUSCH”) transmissions, the set of PUSCH transmissions comprising at least two PUSCH transmissions. In one embodiment, the processor 705 determines a channel occupancy time (“COT”) initiator for each PUSCH transmission of the set of PUSCH transmissions and determines a set of COTs associated with the set of PUSCH transmissions based on the determined COT initiator for each PUSCH transmission of the set of PUSCH transmissions. In one embodiment, the transceiver 725 transmits the set of PUSCH transmissions without transmitting a set of symbols of the set of PUSCH transmissions that overlap with idle periods of the determined set of COTs.

In one embodiment, the processor 705 determines the COT initiator for each PUSCH transmission of the set of PUSCH transmissions based on the scheduling DCI.

In one embodiment, the COT initiator for all PUSCH transmissions of the set of PUSCH transmissions is the same.

In one embodiment, at least two PUSCH transmissions of the set of PUSCH transmissions have a different COT initiator.

In one embodiment, the set of PUSCH transmissions are contiguous PUSCH transmissions without a time gap in between transmissions and are associated with the same COT initiator.

In one embodiment, each PUSCH transmission of the set of PUSCH transmissions has a separate start and length indicator value (“SLIV”) and mapping type.

In one embodiment, the scheduling DCI indicates a row index from a PUSCH time allocation table, the row comprising time domain scheduling information including a starting symbol and a length of each PUSCH transmission of the set of PUSCH transmissions and the COT initiator for each PUSCH transmission of the set of PUSCH transmissions.

In one embodiment, the processor 705 places each PUSCH transmission of the set of PUSCH transmissions in at least one group, a bit in the scheduling DCI indicating the COT initiator for each group of the set of PUSCH transmissions.

In one embodiment, the processor 705 determines the COT initiator for a subset of PUSCH transmissions of the set of PUSCH transmissions based on the scheduling DCI.

In one embodiment, at least one last symbol of a first PUSCH transmission of the set of PUSCH transmissions is an invalid symbol in response to the first PUSCH transmission and a second PUSCH transmission of the set of PUSCH transmissions having different COT initiators.

In one embodiment, the transceiver 725 receives a second DCI after the scheduling DCI and the processor determines the set of COTs associated with at least a portion of the set of PUSCH transmissions based on the scheduling DCI and the second DCI.

In one embodiment, the set of PUSCH transmissions comprises a subset of PUSCH transmissions associated with repetitions of a transport block.

In one embodiment, the repetitions of the transport block correspond to repetition type B and wherein actual repetitions associated with a nominal repetition have the same COT

In one embodiment, the COT initiator for the subset of PUSCH transmissions is a gNB and a PUSCH of the subset of PUSCH transmissions overlaps with an idle period of the COT corresponding to the COT initiator, the processor determining invalid symbols based on the overlap and dropping remaining symbols of the PUSCH after the determined invalid symbols.

In one embodiment, the transceiver 725 does not transmit in the determined invalid symbols.

FIG. 8 depicts one embodiment of a network apparatus 800 that may be used for channel occupancy initiator determination for transmissions in unlicensed spectrum, according to embodiments of the disclosure. In some embodiments, the network apparatus 800 may be one embodiment of a RAN node and its supporting hardware, such as the base unit 121 and/or gNB, described above. Furthermore, network apparatus 800 may include a processor 805, a memory 810, an input device 815, an output device 820, and a transceiver 825. In certain embodiments, the network apparatus 800 does not include any input device 815 and/or output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2, N3, N5, N6 and/or N7 interfaces. Other network interfaces 840 may be supported, as understood by one of ordinary skill in the art.

When implementing a NEF, the network interface(s) 840 may include an interface for communicating with an application function (i.e., N5) and with at least one network function (e.g., UDR, SFC function, UPF) in a mobile communication network, such as the mobile core network 130.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825. In certain embodiments, the processor 805 may include an application processor (also known as “main processor”) which manages application-domain and operating system (“OS”) functions and a baseband processor (also known as “baseband radio processor”) which manages radio function. In various embodiments, the processor 805 controls the network apparatus 800 to implement the above described network entity behaviors (e.g., of the gNB) for channel occupancy initiator determination for transmissions in unlicensed spectrum.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data relating to CSI enhancements for higher frequencies. For example, the memory 810 may store parameters, configurations, resource assignments, policies, and the like as described above. In certain embodiments, the memory 810 also stores program code and related data, such as an operating system (“OS”) or other controller algorithms operating on the network apparatus 800, and one or more software applications.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, may include any known electronically controllable display or display device. The output device 820 may be designed to output visual, audible, and/or haptic signals. In some embodiments, the output device 820 includes an electronic display capable of outputting visual data to a user. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, all or portions of the output device 820 may be located near the input device 815.

As discussed above, the transceiver 825 may communicate with one or more remote units and/or with one or more interworking functions that provide access to one or more PLMNs. The transceiver 825 may also communicate with one or more network functions (e.g., in the mobile core network 80). The transceiver 825 operates under the control of the processor 805 to transmit messages, data, and other signals and also to receive messages, data, and other signals. For example, the processor 805 may selectively activate the transceiver (or portions thereof) at particular times in order to send and receive messages.

The transceiver 825 may include one or more transmitters 830 and one or more receivers 835. In certain embodiments, the one or more transmitters 830 and/or the one or more receivers 835 may share transceiver hardware and/or circuitry. For example, the one or more transmitters 830 and/or the one or more receivers 835 may share antenna(s), antenna tuner(s), amplifier(s), filter(s), oscillator(s), mixer(s), modulator/demodulator(s), power supply, and the like. In one embodiment, the transceiver 825 implements multiple logical transceivers using different communication protocols or protocol stacks, while using common physical hardware.

In one embodiment, the transceiver 825 transmits, to a user equipment (“UE”), a scheduling downlink control information (“DCI”) for scheduling a set of physical uplink shared channel (“PUSCH”) transmissions, the set of PUSCH transmissions comprising at least two PUSCH transmissions and receives, from the UE, the set of PUSCH transmissions, the set of PUSCH transmissions not comprising a set of symbols that overlap with idle periods of a set of channel occupancy times (“COTs”) associated with the set of PUSCH transmissions.

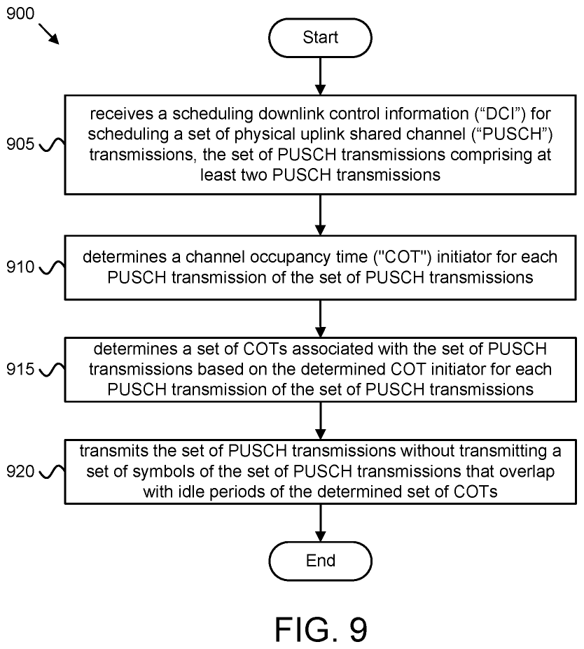

FIG. 9 is a flowchart diagram of a method 900 for channel occupancy initiator determination for transmissions in unlicensed spectrum. The method 900 may be performed by a UE as described herein, for example, the remote unit 105 and/or the user equipment apparatus 700. In some embodiments, the method 900 may be performed by a processor executing program code, for example, a microcontroller, a microprocessor, a CPU, a GPU, an auxiliary processing unit, a FPGA, or the like.

In one embodiment, the method 900 begins and receives 905 a scheduling downlink control information (“DCI”) for scheduling a set of physical uplink shared channel (“PUSCH”) transmissions, the set of PUSCH transmissions comprising at least two PUSCH transmissions. In one embodiment, the method 900 determines 910 a channel occupancy time (“COT”) initiator for each PUSCH transmission of the set of PUSCH transmissions. In one embodiment, the method 900 determines 915 a set of COTs associated with the set of PUSCH transmissions based on the determined COT initiator for each PUSCH transmission of the set of PUSCH transmissions. In one embodiment, the method 900 transmits 920 the set of PUSCH transmissions without transmitting a set of symbols of the set of PUSCH transmissions that overlap with idle periods of the determined set of COTs, and the method 900 ends.

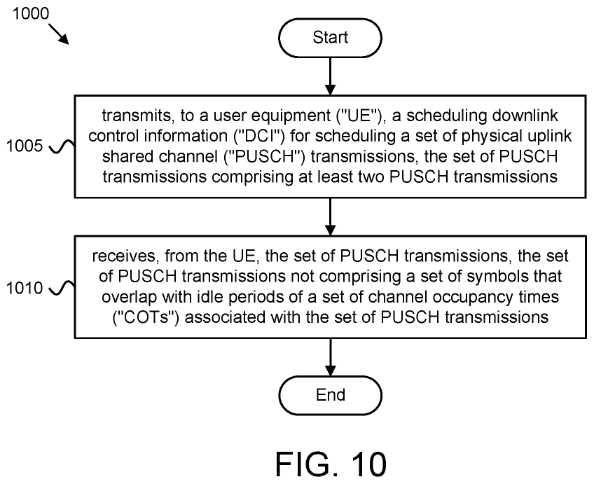

FIG. 10 is a flowchart diagram of a method 1000 for channel occupancy initiator determination for transmissions in unlicensed spectrum. The method 1000 may be performed by a network device as described herein, for example, the base unit 121, a gNB, and/or the network equipment apparatus 800. In some embodiments, the method 1000 may be performed by a processor executing program code, for example, a microcontroller, a microprocessor, a CPU, a GPU, an auxiliary processing unit, a FPGA, or the like.

In one embodiment, the method 1000 transmits 1005, to a user equipment (“UE”), a scheduling downlink control information (“DCI”) for scheduling a set of physical uplink shared channel (“PUSCH”) transmissions, the set of PUSCH transmissions comprising at least two PUSCH transmissions. In one embodiment, the method 1000 receives 1010, from the UE, the set of PUSCH transmissions, the set of PUSCH transmissions not comprising a set of symbols that overlap with idle periods of a set of channel occupancy times (“COTs”) associated with the set of PUSCH transmissions, and the method 1000 ends.

A first apparatus is disclosed for channel occupancy initiator determination for transmissions in unlicensed spectrum. The first apparatus may include a UE as described herein, for example, the remote unit 105 and/or the user equipment apparatus 700. In some embodiments, the first apparatus may include a processor executing program code, for example, a microcontroller, a microprocessor, a CPU, a GPU, an auxiliary processing unit, a FPGA, or the like.

In one embodiment, the first apparatus includes a transceiver that receives a scheduling downlink control information (“DCI”) for scheduling a set of physical uplink shared channel (“PUSCH”) transmissions, the set of PUSCH transmissions comprising at least two PUSCH transmissions. In one embodiment, the first apparatus includes a processor that determines a channel occupancy time (“COT”) initiator for each PUSCH transmission of the set of PUSCH transmissions and determines a set of COTs associated with the set of PUSCH transmissions based on the determined COT initiator for each PUSCH transmission of the set of PUSCH transmissions. In one embodiment, the transceiver transmits the set of PUSCH transmissions without transmitting a set of symbols of the set of PUSCH transmissions that overlap with idle periods of the determined set of COTs.

In one embodiment, the processor determines the COT initiator for each PUSCH transmission of the set of PUSCH transmissions based on the scheduling DCI.

In one embodiment, the COT initiator for all PUSCH transmissions of the set of PUSCH transmissions is the same.

In one embodiment, at least two PUSCH transmissions of the set of PUSCH transmissions have a different COT initiator.

In one embodiment, the set of PUSCH transmissions are contiguous PUSCH transmissions without a time gap in between transmissions and are associated with the same COT initiator.

In one embodiment, each PUSCH transmission of the set of PUSCH transmissions has a separate start and length indicator value (“SLIV”) and mapping type.

In one embodiment, the scheduling DCI indicates a row index from a PUSCH time allocation table, the row comprising time domain scheduling information including a starting symbol and a length of each PUSCH transmission of the set of PUSCH transmissions and the COT initiator for each PUSCH transmission of the set of PUSCH transmissions.

In one embodiment, the processor places each PUSCH transmission of the set of PUSCH transmissions in at least one group, a bit in the scheduling DCI indicating the COT initiator for each group of the set of PUSCH transmissions.

In one embodiment, the processor determines the COT initiator for a subset of PUSCH transmissions of the set of PUSCH transmissions based on the scheduling DCI.

In one embodiment, at least one last symbol of a first PUSCH transmission of the set of PUSCH transmissions is an invalid symbol in response to the first PUSCH transmission and a second PUSCH transmission of the set of PUSCH transmissions having different COT initiators.

In one embodiment, the transceiver receives a second DCI after the scheduling DCI and the processor determines the set of COTs associated with at least a portion of the set of PUSCH transmissions based on the scheduling DCI and the second DCI.

In one embodiment, the set of PUSCH transmissions comprises a subset of PUSCH transmissions associated with repetitions of a transport block.

In one embodiment, the repetitions of the transport block correspond to repetition type B and wherein actual repetitions associated with a nominal repetition have the same COT

In one embodiment, the COT initiator for the subset of PUSCH transmissions is a gNB and a PUSCH of the subset of PUSCH transmissions overlaps with an idle period of the COT corresponding to the COT initiator, the processor determining invalid symbols based on the overlap and dropping remaining symbols of the PUSCH after the determined invalid symbols.

In one embodiment, the transceiver does not transmit in the determined invalid symbols.

A first method is disclosed for channel occupancy initiator determination for transmissions in unlicensed spectrum. The first method may be performed by a UE as described herein, for example, the remote unit 105 and/or the user equipment apparatus 700. In some embodiments, the first method may be performed by a processor executing program code, for example, a microcontroller, a microprocessor, a CPU, a GPU, an auxiliary processing unit, a FPGA, or the like.

In one embodiment, the first method receives a scheduling downlink control information (“DCI”) for scheduling a set of physical uplink shared channel (“PUSCH”) transmissions, the set of PUSCH transmissions comprising at least two PUSCH transmissions. In one embodiment, the first method determines a channel occupancy time (“COT”) initiator for each PUSCH transmission of the set of PUSCH transmissions and determines a set of COTs associated with the set of PUSCH transmissions based on the determined COT initiator for each PUSCH transmission of the set of PUSCH transmissions. In one embodiment, the first method transmits the set of PUSCH transmissions without transmitting a set of symbols of the set of PUSCH transmissions that overlap with idle periods of the determined set of COTs.

In one embodiment, the first method determines the COT initiator for each PUSCH transmission of the set of PUSCH transmissions based on the scheduling DCI.

In one embodiment, the COT initiator for all PUSCH transmissions of the set of PUSCH transmissions is the same.

In one embodiment, at least two PUSCH transmissions of the set of PUSCH transmissions have a different COT initiator.

In one embodiment, the set of PUSCH transmissions are contiguous PUSCH transmissions without a time gap in between transmissions and are associated with the same COT initiator.

In one embodiment, each PUSCH transmission of the set of PUSCH transmissions has a separate start and length indicator value (“SLIV”) and mapping type.

In one embodiment, the scheduling DCI indicates a row index from a PUSCH time allocation table, the row comprising time domain scheduling information including a starting symbol and a length of each PUSCH transmission of the set of PUSCH transmissions and the COT initiator for each PUSCH transmission of the set of PUSCH transmissions.

In one embodiment, the first method places each PUSCH transmission of the set of PUSCH transmissions in at least one group, a bit in the scheduling DCI indicating the COT initiator for each group of the set of PUSCH transmissions.

In one embodiment, the first method determines the COT initiator for a subset of PUSCH transmissions of the set of PUSCH transmissions based on the scheduling DCI.

In one embodiment, at least one last symbol of a first PUSCH transmission of the set of PUSCH transmissions is an invalid symbol in response to the first PUSCH transmission and a second PUSCH transmission of the set of PUSCH transmissions having different COT initiators.

In one embodiment, the first method receives a second DCI after the scheduling DCI and determines the set of COTs associated with at least a portion of the set of PUSCH transmissions based on the scheduling DCI and the second DCI.

In one embodiment, the set of PUSCH transmissions comprises a subset of PUSCH transmissions associated with repetitions of a transport block.

In one embodiment, the repetitions of the transport block correspond to repetition type B and wherein actual repetitions associated with a nominal repetition have the same COT initiator.

In one embodiment, the COT initiator for the subset of PUSCH transmissions is a gNB and a PUSCH of the subset of PUSCH transmissions overlaps with an idle period of the COT corresponding to the COT initiator, the processor determining invalid symbols based on the overlap and dropping remaining symbols of the PUSCH after the determined invalid symbols.

In one embodiment, the first method does not transmit in the determined invalid symbols.

A second apparatus is disclosed for channel occupancy initiator determination for transmissions in unlicensed spectrum. The second apparatus may include a network device as described herein, for example, the base unit 121, a gNB, and/or the network equipment apparatus 800. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver that transmits, to a user equipment (“UE”), a scheduling downlink control information (“DCI”) for scheduling a set of physical uplink shared channel (“PUSCH”) transmissions, the set of PUSCH transmissions comprising at least two PUSCH transmissions and receives, from the UE, the set of PUSCH transmissions, the set of PUSCH transmissions not comprising a set of symbols that overlap with idle periods of a set of channel occupancy times (“COTs”) associated with the set of PUSCH transmissions.

A second method is disclosed for channel occupancy initiator determination for transmissions in unlicensed spectrum. The second method may be performed by a network device as described herein, for example, the base unit 121, a gNB, and/or the network equipment apparatus 800. In some embodiments, the second method may be performed by a processor executing program code, for example, a microcontroller, a microprocessor, a CPU, a GPU, an auxiliary processing unit, a FPGA, or the like.

In one embodiment, the second method transmits, to a user equipment (“UE”), a scheduling downlink control information (“DCI”) for scheduling a set of physical uplink shared channel (“PUSCH”) transmissions, the set of PUSCH transmissions comprising at least two PUSCH transmissions and receives, from the UE, the set of PUSCH transmissions, the set of PUSCH transmissions not comprising a set of symbols that overlap with idle periods of a set of channel occupancy times (“COTs”) associated with the set of PUSCH transmissions.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) apparatus, the apparatus comprising:
a transceiver that receives a scheduling downlink control information (“DCI”) for scheduling a set of physical uplink shared channel (“PUSCH”) transmissions, the set of PUSCH transmissions comprising at least two PUSCH transmissions; and
a processor that:
determines a channel occupancy time (“COT”) initiator for each PUSCH transmission of the set of PUSCH transmissions; and
determines a set of COTs associated with the set of PUSCH transmissions based on the determined COT initiator for each PUSCH transmission of the set of PUSCH transmissions,
wherein the transceiver transmits the set of PUSCH transmissions without transmitting a set of symbols of the set of PUSCH transmissions that overlap with idle periods of the determined set of COTs.

2. The apparatus of claim 1, wherein the processor determines the COT initiator for each PUSCH transmission of the set of PUSCH transmissions based on the scheduling DCI.

3. The apparatus of claim 2, wherein the COT initiator for all PUSCH transmissions of the set of PUSCH transmissions is the same.

4. The apparatus of claim 2, wherein the set of PUSCH transmissions are contiguous PUSCH transmissions without a time gap in between transmissions and are associated with the same COT initiator.

5. The apparatus of claim 2, wherein each PUSCH transmission of the set of PUSCH transmissions has a separate start and length indicator value (“SLIV”) and mapping type.

6. The apparatus of claim 1, wherein the scheduling DCI indicates a row index from a PUSCH time allocation table, the row comprising time domain scheduling information including a starting symbol and a length of each PUSCH transmission of the set of PUSCH transmissions and the COT initiator for each PUSCH transmission of the set of PUSCH transmissions.

7. The apparatus of claim 1, wherein the processor places each PUSCH transmission of the set of PUSCH transmissions in at least one group, a bit in the scheduling DCI indicating the COT initiator for each group of the set of PUSCH transmissions.

8. The apparatus of claim 1, wherein the processor determines the COT initiator for a subset of PUSCH transmissions of the set of PUSCH transmissions based on the scheduling DCI.

9. The apparatus of claim 1, wherein at least one last symbol of a first PUSCH transmission of the set of PUSCH transmissions is an invalid symbol in response to the first PUSCH transmission and a second PUSCH transmission of the set of PUSCH transmissions having different COT initiators.

10. The apparatus of claim 1, wherein the set of PUSCH transmissions comprises a subset of PUSCH transmissions associated with repetitions of a transport block.

11. The apparatus of claim 10, wherein the repetitions of the transport block correspond to repetition type B and wherein actual repetitions associated with a nominal repetition have the same COT initiator.

12. The apparatus of claim 11, wherein the COT initiator for the subset of PUSCH transmissions is a gNB and a PUSCH of the subset of PUSCH transmissions overlaps with an idle period of the COT corresponding to the COT initiator, the processor determining invalid symbols based on the overlap and dropping remaining symbols of the PUSCH after the determined invalid symbols.

13. The apparatus of claim 12, wherein the transceiver does not transmit in the determined invalid symbols.

14. A method at a user equipment (“UE”), the method comprising:
receiving a scheduling downlink control information (“DCI”) for scheduling a set of physical uplink shared channel (“PUSCH”) transmissions, the set of PUSCH transmissions comprising at least two PUSCH transmissions;
determining a channel occupancy time (“COT”) initiator for each PUSCH transmission of the set of PUSCH transmissions;
determining a set of COTs associated with the set of PUSCH transmissions based on the determined COT initiator for each PUSCH transmission of the set of PUSCH transmissions; and
transmitting the set of PUSCH transmissions without transmitting a set of symbols of the set of PUSCH transmissions that overlap with idle periods of the determined set of COTs.

15. A network node apparatus, the apparatus comprising:
a transceiver that:
transmits, to a user equipment (“UE”), a scheduling downlink control information (“DCI”) for scheduling a set of physical uplink shared channel (“PUSCH”) transmissions, the set of PUSCH transmissions comprising at least two PUSCH transmissions; and
receives, from the UE, the set of PUSCH transmissions, the set of PUSCH transmissions not comprising a set of symbols that overlap with idle periods of a set of channel occupancy times (“COTs”) associated with the set of PUSCH transmissions.
